(19) United States
(12) Patent Application Publication
(10) Pub. No.: US 2018/0294738 A1
(43) Pub. Date: Oct. 11, 2018

(54) BIDIRECTIONAL ENERGY TRANSFER CONTROL

(71) Applicant: ITT MANUFACTURING ENTERPRISES LLC., Wilmington, DE (US)

(72) Inventors: Dean P. WILLIAMS, Moravia, NY (US); Lee EMPRINGHAM, Beeston, Nottingham (GB); Liliana V. DE LILLO, Beeston, Nottingham (GB)

(21) Appl. No.: 15/574,232

(22) PCT Filed: May 13, 2016
(86) PCT No.: PCT/EP2016/006098

§ 371 Date: Nov. 15, 2017

(30) Foreign Application Priority Data
May 15, 2015 (GB) 1508382.7

(51) Int. Cl. H02M 5/293

(52) U.S. Cl. CPC H02M 5/293

(57) ABSTRACT

This invention relates to the field of matrix converters and more specifically to the field of matrix converters comprising bidirectional switches. There is proposed a concept of providing a minimum transistor switching period for any given transistor in the matrix converter. Such a minimum transistor switching period may be induced by introducing a delay into a commutation sequence that is typically used to switch an output from a first input to a second input.

### FIELD OF THE INVENTION

This invention relates to the field of matrix converters and more specifically to the field of matrix converters comprising bidirectional switches.

### BACKGROUND OF THE INVENTION

A matrix converter is typically a single stage AC-AC converter that uses an array of switches to convert a first AC signal (of any number of phases) to a second AC signal (of any number of phases) with arbitrary magnitude and frequency. One advantage of a matrix converter is that it does not need any large energy storage elements.

Typical matrix converters require each switch in the array of switches to be a bidirectional switch capable of blocking voltage and conducting current in both directions. A two-diode two-transistor bidirectional switch is a known method of independently controlling the direction of the current within a matrix converter. A four step sequence for commutation of such a bidirectional switch (i.e. a method of turning a first bidirectional switch off and a second switch on through selective switching of their transistors) is known.

One known modulation technique for a matrix converter uses Space Vector Modulation (SVM) to perform modulation of the first AC signal. Several SVM techniques are known to those skilled in the art, such as three-zero, two-zero and one-zero methods.

### SUMMARY OF THE INVENTION

The invention is defined by the claims.

According to a first aspect of the inventive concept, there is provided a matrix converter comprising: m input nodes for connection to an m-phase voltage source, where m is at least one; n output nodes for connection to an n-phase load where n is at least one and at least one of m or n is two or more; m×n bidirectional switches, wherein each bidirectional switch is connected between a single input node and a single output node, such that each output node is selectively connectable to each input node by a bidirectional switch; and a controller connected to control the conductivity of the said bidirectional switches, such that the bidirectional connection between each input node to each output node is selectively controllable, wherein the controller is adapted such that the minimum time period between changing the conductivity of any single bidirectional switch is no less than a predetermined time period.

In other words, a matrix converter may be adapted such that a bidirectional switch has a minimum switching time, such that no single bidirectional switch may pulse on-off-on or off-on-off within a predetermined time period. This does not exclude the possibility that a difference in time period between a first bidirectional switch switching state (e.g. from off to on) and a second bidirectional switch switching state may be less than the predetermined time period.

In at least one preferable embodiment, the matrix converter is adapted wherein each bidirectional switch comprises at least one transistor; the controller is connected to control the conductivity of each transistor; and the controller is adapted such that the minimum time period between changing the conductivity of any single transistor is no less than the predetermined time period.

In other words there is provided a matrix converter comprising an array of m×n bidirectional switches. Connected to this array is a plurality of m input nodes and n output nodes. Each bidirectional switch is connected between a unique pair of an input and an output node, such that each of the input and output nodes are connectable together by a bidirectional switch. The bidirectional switches each comprise at least one transistor.

A controller provides a variable voltage connection to each transistor of the said bidirectional switches in order to control the conductivity of the transistors (i.e. control the current flow through any given transistor). That is to say that a controller allows for varying voltages to be applied to a gate of each transistor to control the conductivity through the transistor (e.g. from a source or collector connected to an input node to a drain or emitter connected to an output node). The controller may thereby controllably connect any input node to any output node.

The controller is adapted to only change the conductivity of any single transistor with a minimum predetermined time delay, i.e. each transistor has a maximum allowed switching event frequency, controlled by the controller. Only allowing the conductivity of a given transistor to change at a maximum frequency in this manner may permit excessive thermal stress in the devices to be avoided.

This does not exclude the possibility of changing the conductivity of different transistors in a shorter time period. For example, at a first point in time (ti₁) a first transistor may allow no current to flow and a second transistor may allow current to flow; at a second point in time (ti₂), the conductivity of the first transistor may by altered to allow current to flow. At a third point in time (ti₃), less than a predetermined time period (t_{pd}) after the second point in time (i.e. ti₃−ti₂<t_{pd}), the conductivity of the second transistor may be altered to allow no current to flow.

Optionally, the controller is a field-programmable gate array, FPGA. Such an FPGA may, for example, provide this minimum time period between changing the conductivity by acting as a state machine to provide timed ‘hold states’ wherein the applied voltage (that changes conductivity) to any given transistor may only be changed when the set time period of the ‘hold state’ has elapsed, and hence the state is exited.

Such a matrix converter may further comprise a microcontroller connected to the FPGA, the microcontroller being adapted to select to which input node an output node is bidirectionally connected.

The matrix converter may be adapted such that time period between changing the conductivity of any single transistor of the bidirectional switches is dependent upon the n-phase load driven by the output nodes.

The predetermined time period may be calculated based on any number of factors, for example: the phase of the load; the phase of the voltage source; the modulation method; the specification of the switches and their thermal characteristics (e.g. the technology of the transistors and type of packaging used); or the voltage to be supplied to the load or the loss to be endured by the switches.

The matrix converter may further comprise at least one capacitor connected between each of the input nodes.

The size of the capacitors may be dependent upon the high frequency harmonic performance required. They may be large enough to ensure that the voltage ripple at the input of the converter is sufficiently small to allow correct operation of the converter itself. This size is easily calculable to the skilled reader.

In some embodiments, each output node is bidirectionally connected to only one input node at a time.

In other words bidirectional current may only be permitted to flow to an output node from a single input node. Put another way, a voltage supply provided at an input node may provide bidirectional current to more than one output node and the connected loads; but any given output node may not receive bidirectional current from more than one input node.

An exemplary bidirectional switch may comprise: a first transistor and a first diode arranged in series; and a second transistor and a second diode arranged in series, wherein the first and second transistor are arranged back-to-back, such that the bidirectional switch is configurable to provide a first unidirectional connection from the associated input node to the associated output node, or a second unidirectional connection from the said output node to the said input node.

In other words each bidirectional switch may comprise two uni-directional switches arranged in anti-series.

One configuration of a possible bidirectional switch comprises a first and second transistor and a first and second diode. Each transistor comprises a gate, a collector and an emitter as in conventional electronics. In one embodiment the transistors are arranged such that the emitter of the first transistor is connected to the emitter of the second transistor to provide bidirectional current controllability. In such a configuration an input node of the matrix converter may be connected to the collector of the first transistor, and an output node may be connected to the collector of the second transistor. For the present configuration, the first diode spans from the emitter of the first transistor to the said output node, and the second diode spans from the emitter of the second transistor to the said input node. Thus the first transistor and the first diode are serially connected, and the second transistor and second diode are also serially connected.

Alternative arrangements of a bidirectional switch having a first and second transistor and a first and second diode are possible. For example, the transistors may be arranged such that the collector of the first transistor is connected to the collector of the second transistor to provide bidirectional current controllability. Correspondingly, an input node of the matrix converter may be provided to the emitter of the first transistor, and an output node of the matrix converter may be provided to the emitter of the second transistor. For this configuration, the first diode spans from the collector of the first transistor to the said output node, and the second diode spans from the collector of the second transistor to the said input node. Thus the first transistor and the first diode remain serially connected, and the second transistor and second diode also remain serially connected.

A matrix converter with such bidirectional switches as these may be adapted such that an output node is unidirectionally connected to no more than two input nodes at a time.

In other words, only a maximum of two uni-directional switches of the bi-directional switches associated with any given output node may be at a high conductivity at any given point in time. Thus an exemplary output node may have a first unidirectional connection to a first input node (e.g. current is permitted to flow from the first input node to the exemplary output node) and a second unidirectional connection to a second input node (e.g. current is permitted to flow from the exemplary output node to the second input node).

In some embodiments the controller is adapted such that the predetermined time period is no less than 2.5 μs, for example 2.5 μs.

In further embodiments the controller is further adapted such that the minimum time period between changing the conductivity of any single transistor of the bidirectional switches is no less than 3.5 μs.

It may be preferable in some embodiments to limit the minimum time period between changing the conductivity of any single transistor of the bidirectional switch to be no more than 5 μs. In particular, setting a minimum period which is too long may give undesired distortion in the output.

According to another aspect of the inventive concept there is provided a method of switching a bidirectional connection to an output node from a first input node to a second input node, wherein the first input node is connectable to the output node by a first bidirectional switch comprising a first transistor and a first diode arranged in series; and a second transistor and a second diode arranged in series, wherein the first and second transistor are arranged back-to-back; and the second input node is connectable to the output node by a second bidirectional switch comprising: a third transistor and a third diode arranged in series; and a fourth transistor and a fourth diode arranged in series, wherein the third and fourth transistor are arranged back-to-back, wherein the conductivity of each transistor is controllable by a controller to switch between a higher, on, conductivity and a lower, off, conductivity, at an initial state the first and second transistor are both on, and the third and fourth transistor are both off, the method comprising: at a first point in time, switching the first transistor off; at a second point in time, switching the third transistor on; at a third point in time, switching the second transistor off; at a fourth point in time, switching the fourth transistor on; characterized in that the method further comprises: at the fourth point in time, latching the fourth transistor to remain on; at a fifth point in time, unlatching the fourth transistor, wherein the fifth point in time is no less than a predetermined time period after the fourth point in time.

For example, this predetermined time period is preferably 2.5 μs; however in other embodiments this predetermined time period may be 3.5 μs or 5 μs.

The method may be adapted wherein there is a predetermined maximum time period between at least one of the following: the first and second point in time; the second and third point in time; and the third and fourth point in time.

For example, this predetermined maximum time period may be 1 μs.

There is also provided a method of operating a matrix converter having at least one output node and at least two input nodes, wherein each output node is bidirectionally connected to each input node by a bidirectional switch, the method comprising: using a space vector modulation technique to control the order of switching of the bidirectional connections between at least one output node and at least two input nodes, wherein the step of switching of the bidirectional connection is performed as described above.

The space vector modulation technique may for example be a two-zero modulation method. In other embodiments, the space vector modulation technique is a three-zero or one-zero modulation method.

A two-zero modulation method is herein shown to provide an n-phase output with improved total harmonic distortion. For some situations, the three-zero modulation method may provide an improved overall performance.

### BRIEF DESCRIPTION OF THE DRAWINGS

Examples of the invention will now be described in detail with reference to the accompanying drawings, in which:

FIG. 1 illustrates a matrix converter according to a first exemplary embodiment;

FIG. 2 depicts a detailed view of the matrix converter according to the first exemplary embodiment;

FIG. 3 is a representative graph of a known commutation sequence;

FIG. 4 is a representative graph of a commutation sequence according to the first exemplary embodiment;

FIG. 5 illustrates a matrix converter according to a second exemplary embodiment;

FIG. 6 is a representative diagram of a three-zero space vector modulation technique for the second exemplary embodiment;

FIG. 7 is a representative diagram of a two-zero space vector modulation technique for the second exemplary embodiment;

FIG. 8 is a simulated graph of the total harmonic distortion (THD) of the output current for increasing modulation index of a three-zero and a two-zero space vector modulation technique;

FIG. 9 is a simulated graph of the total harmonic distortion (THD) of the output current for increasing commutation hold time of a three-zero and a two-zero space vector modulation technique;

FIG. 10 is a simulated graph of the total harmonic distortion (THD) of the input current for increasing modulation index of a three-zero and a two-zero space vector modulation technique;

FIG. 11 is a simulated graph of the total harmonic distortion (THD) of the input current for increasing commutation hold time of a three-zero and a two-zero space vector modulation technique; and

FIG. 12 is a representative flow chart of a method for a commutation sequence according to the first exemplary embodiment.

### DETAILED DESCRIPTION OF THE EMBODIMENTS

The invention provides a matrix converter capable of converting a multi-phase input signal to a multi-phase output signal. There is proposed a concept of providing a minimum transistor switching period for any given transistor in the matrix converter. The minimum transistor switching period for any given transistor thereby implies a minimum bidirectional switch switching period as well.

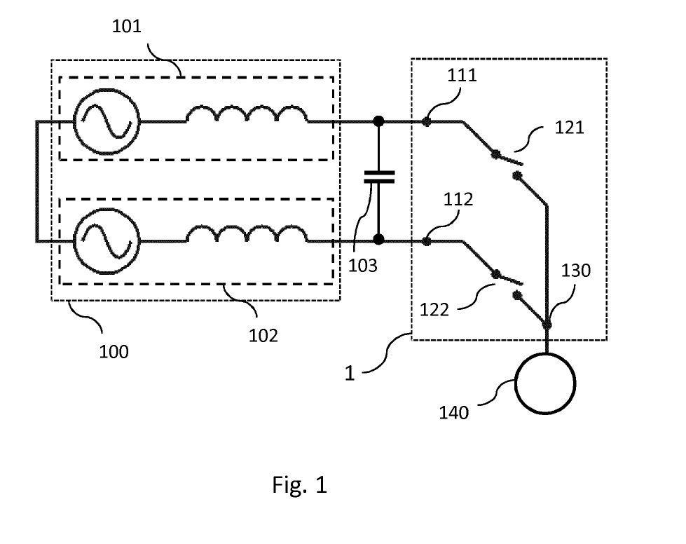

With reference to FIG. 1, a first embodiment of a matrix converter 1 is shown. The matrix converter 1 is a simple two-phase to single-phase matrix converter. In other words, a two-phase input signal 100 may be modulated by the matrix converter 1 to a single-phase output load 140. The matrix converter 1 comprises a first 111 and second 112 input node for connection to a voltage source 100 of a first 101 and second 102 phase. The matrix converter 1 also comprises an output node 130 for connection to the output load 140. A capacitor 103 provides a path for the inductive current of each phase. The matrix converter comprises a first 121 and second 122 bidirectional switch that allow for the modulation of the two phase input signal 101, 102 to the output load 140. To modulate the two phase input signal, the two bidirectional switches may be alternately switched on or off (i.e. allow a bidirectional current to flow through the switch). Control of this switching may be performed, for example, by a field-programmable gate array, FPGA, (not shown).

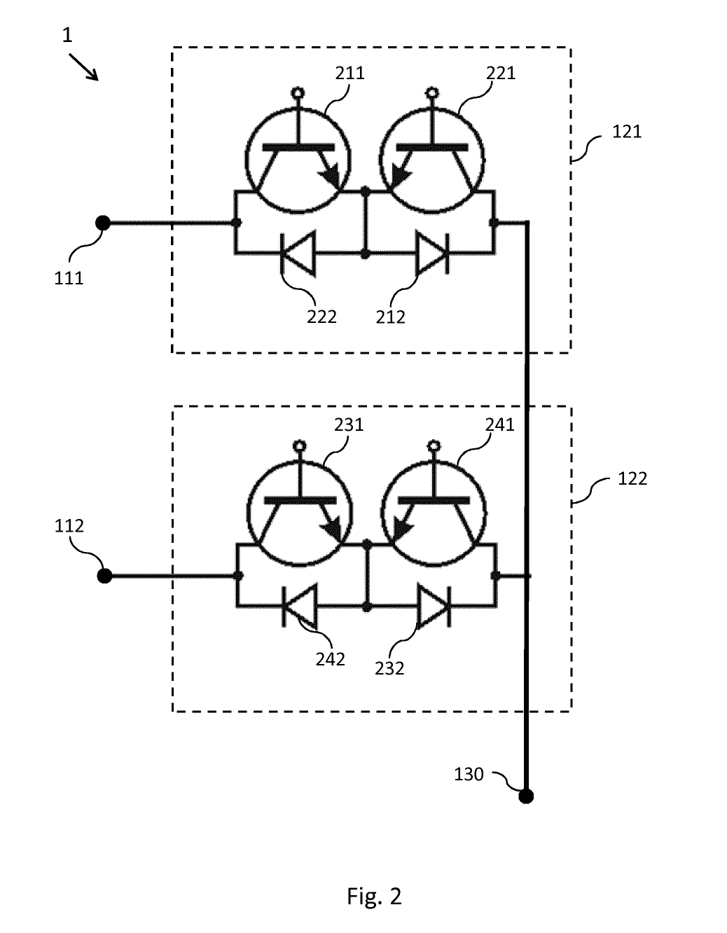

FIG. 2 depicts the exemplary matrix converter 1 in more detail. There is shown the first 121 and second 122 exemplary bidirectional switch for said matrix converter 1.

The exemplary first bidirectional switch 121 comprises a first 211, 212 and second 221, 222 unidirectional switch arranged in anti-series. The first unidirectional switch 211, 212 controls the current flow in a single (e.g. forward, from the associated input node 111 to the associated output node 130) direction; whereas the second unidirectional switch 221, 222 controls the current flow in the opposite (e.g. reverse, from the associated output node 130 to the associated input node 111) direction. Thus the current in the forward and reverse direction from each input node to the output node may be independently controlled by the bidirectional switch. Such a bidirectional switch may be alternatively named a switching cell.

Similarly, the second bidirectional switch 122 is arranged with the same components and in the same manner as the first bidirectional switch 121—that is to say comprising a first unidirectional switch 231, 232 and a second unidirectional switch 241, 242 arranged in anti-series.

Voltage applied to the gate of a transistor, by for example an FPGA, controls the conductivity of the said transistor. If a two-level voltage signal (e.g. a voltage signal that is either 3.3V or 0V) is applied to the said gate, then the transistor may be considered to have two states of conductivity, ‘on’ or ‘off’. In the ‘on’ state, the transistor is gated to have a high conductivity, and may allow current to pass through. In the ‘off’ state the transistor has a low conductivity, and may not allow current to pass through. For example the connection of the input node 111 to the output node 130 in both directions of current may be controlled by voltages applied to the gates of the transistors of the bidirectional switch 121. It will be understood by the skilled person that other methods of controlling the transistors and hence the bidirectional switches, such as using a microcontroller, are available without departing from the scope of the invention. Furthermore, other voltage levels (e.g. 5V, 3V) may be applied to the gates to control the conductivity.

As mentioned previously, in one method of modulating the two-phase input signal to the single-phase output load, the bidirectional switches must be alternately switched on and off. To prevent line-to-line short circuits (of the input), no two bidirectional switches associated with a single output node should be switched on at any given moment. In other words, the output node 130 may only be bidirectionally connected to a single input node at any given moment. Similarly, to ensure there is a path for the inductive current of each phase of the input signal, no output node 130 should be wholly disconnected from every input node 112, 111, thereby preventing large over-voltages from occurring. In other words, the output node 130 must always be connected to a phase of the voltage source 100. These two restrictions allow for improved device safety, reliability and longevity.

There is described below one method of safely transferring connection to the output node 130 from the first input node 111 to the second input node 112. This procedure may otherwise be called a commutation, and the steps involved named a commutation sequence.

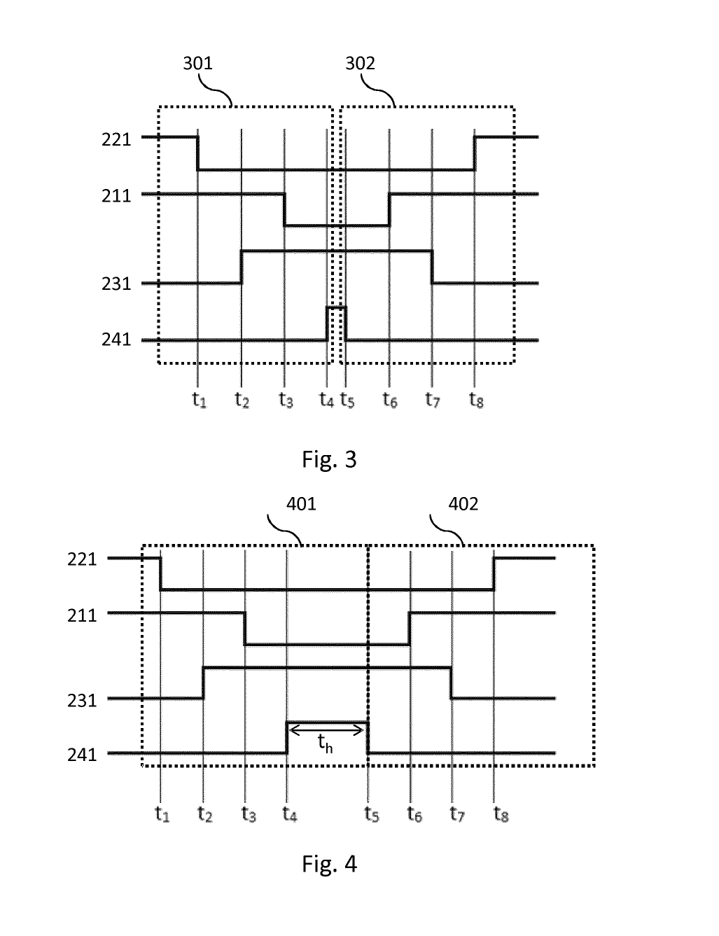

FIG. 3 show a typical (to the prior art) commutation sequence 301 for firstly commutating the connection to the output node 130 from the first input node 111 to the second input node 112 (t₁-t₄) and subsequently reversing the commutation sequence 302 (t₅-t₈). The graph shows representative waveforms of a two-level voltage signal applied to the gates of the respective transistor, turning the transistor on and off accordingly.

Initially, the first bidirectional switch 121 is switched wholly on, and the corresponding forward and reverse current unidirectional switches (i.e. the first unidirectional switch 211, 212 and the second unidirectional switch 221, 222 respectively) are switched on and the associated transistors have a high conductivity allowing current to flow. Similarly, the second bidirectional switch 122 is switched wholly off, and the corresponding forward and reverse current unidirectional switch (i.e. the third unidirectional switch 231, 232 and the fourth unidirectional switch 241, 242 respectively) are switched off and the associated transistors have a low or near-zero conductivity allowing only negligible current to flow.

At a first point in time (t₁) the second transistor 221 (reverse current unidirectional switch of the first bidirectional switch 121) is switched off.

At a second point in time (t₂) the third transistor 231 (forward current unidirectional switch of the second bidirectional switch 122) is switched on.

At a third point in time (t₃) the first transistor 211 (forward current unidirectional switch of the first bidirectional switch 121) is switched off. The first bidirectional switch 121 is now wholly switched off.

At a fourth point in time (t₄) the fourth transistor 241 (reverse current unidirectional switch of the second bidirectional switch 122) is switched on. The second bidirectional switch 122 is now wholly switched on and the commutation sequence complete.

The procedure is then reversed to commutate the connection provided to the output node so that it is again provided by the first input node. That is to say:

At a fifth point in time (t₅) the fourth transistor 241 is switched off.

At a sixth point in time (t₆) the first transistor 211 is switched on.

At a seventh point in time (t₇) the third transistor 231 is switched off.

At an eighth point in time (t₈) the second transistor 221 is switched on.

The commutation sequence described above has no restrictions on the frequency or time periods at which transistors may be switched. There is thus introduced the possibility that if two back-to-back commutations are required, the length of time for which the fourth transistor is switched on (t₅-t₄) may become extremely small.

FIG. 4 illustrates a modified commutation sequence 401 according to an embodiment of the invention. The sequence comprises the same first four points in time as described with reference to FIG. 3. However, the fourth point in time is adapted wherein the voltage applied to the fourth transistor 241 is held for a minimum period of time (tₕ), otherwise called a commutation hold time. In other words, the transistor must remain on for at least the length of time tₕ. Preferably, this minimum period of time is no less than 2.5 μs, and optionally is no less than 3.5 μs. The fourth transistor 241 may, therefore, not be switched off-on-off in less than the minimum period of time.

The second, reverse, commutation sequence 402 may occur immediately following the end of the minimum period of time, such that the fifth point in time (i.e. when the fourth transistor 241 is switched off) may occur immediately following the elapse of the minimum period of time following the fourth transistor switching on at t₄. In the instance the minimum period of time is, for example, no less than 2.5 μs; it follows that:

t₅−t_{4≥}2.5 μs (1)

Following the commutation sequence in this manner ensures that no single transistor of the matrix converter 1 may be turned off-on-off or ‘pulsed’ with an on-period (i.e. the length of time a transistor is on) less than the commutation hold time (predetermined time period), for example 2.5 μs. Furthermore, it may be understood that if the switching between any two bidirectional switch is always performed in the manner described above, no transistor will be pulsed on-off-on with an off-period (i.e. the length of time a transistor is off) less than the commutation hold time.

As the control of voltages applied to the transistors may be performed by a field-programmable gate array (FPGA), it follows that each of the points in time may relate to a ‘state’ of a state machine. In this instance, as the state machine (i.e. FPGA) steps through each state, so each process at the respective point in time is performed. Therefore, for example, at the fourth point in time, a hold state may be entered, wherein no further processes may be performed until a set time period has elapsed, and the hold state is exited. Such an FPGA may therefore provide the proposed requirement that no transistor will be pulsed within a time frame, for example, 2.5 μs.

It should be noted that the commutation sequences described with reference to FIG. 3 and 4 are not limited to switching back and forth between only a pair of bidirectional switches, but may apply to switching between sequences of any number of bidirectional switches. For example, there may be applications where a sequence is demanded to commutate from an initial first bidirectional switch to a second bidirectional switch (e.g. the sequence t₁-t₄), then from the second bidirectional switch to a third bidirectional switch (e.g. in the stead of t₅-t₈). Any number of commutations for supplying an arbitrary output node associated with an arbitrary number of bidirectional switches can thereby be performed.

It will be understood that providing the minimum transistor switching time (e.g. >2.5 μs) also provides a minimum value for the bidirectional switch switching time (i.e. each bidirectional switch may only pulse on-off-on in a limited time period, e.g. >2.5 μs).

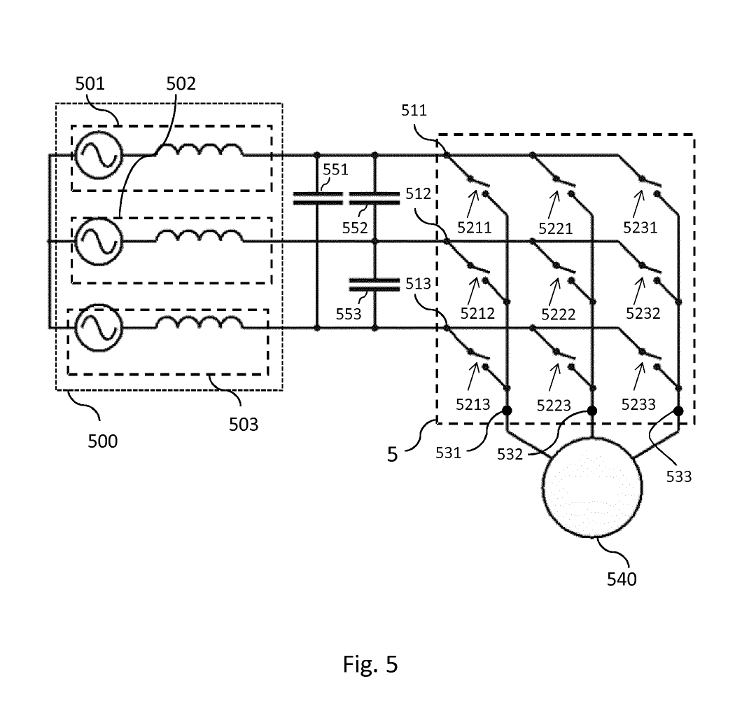

FIG. 5 depicts a matrix converter 5 according to a second exemplary embodiment. The matrix converter 5 is a three-phase to three-phase matrix converter. In other words, the matrix converter 5 comprises: a first 511, second 512 and third 513 input node for connection to a first 501, second 502 and third 503 phase of a voltage supply 500; and a first 531, second 532 and third 533 output node for connection to a first, second and third phase of a load 540. The voltage supply may, for example, be a typical three-phase mains supply. The load 540 may, for example, be an inductive load or capacitive load, such that the matrix converter may comprise an inductive port or a capacitive port or both.

Each output node is connectable to each input node by a bidirectional switch. Thus a total of nine (3×3) bidirectional switches are provided in an array by the matrix converter. A first 551, second 552 and third 553 capacitor provide a path for the inductive current of each phase.

The first output node 531 is connectable to the first 511, second 512 and third 513 input nodes by a first 5211, second 5212 and third 5213 bidirectional switch respectively. The second output node 532 is connectable to the first 511, second 512 and third 513 input nodes by a fourth 5221, fifth 5222 and sixth 5223 bidirectional switch respectively. The third output node 533 is connectable to the first 511, second 512 and third 513 input nodes by a seventh 5231, eighth 5232 and ninth 5233 bidirectional switch respectively. In the present embodiment, each bidirectional switch is in the same configuration as exhibited in FIG. 2.

The same restrictions apply to the second embodiment as to the first. In other words, to prevent line-to-line short circuits (of the voltage source), no two bidirectional switches associated with a single output node should be switched on at any given moment. For example, only one of following may be switched on at any given moment: the first bidirectional switch 5211; the second bidirectional switch 5212; and the third bidirectional switch 5213. Similarly, to ensure there is a path for the inductive current of each phase of the input signal, no output node 231,232,533 should be disconnected from every input node 511, 512, 513 thereby preventing large over-voltages from occurring. In other words, each output node 531, 532, 533 must always be connected to a phase of the voltage source 500. These two restrictions allow for improved device safety, reliability and longevity.

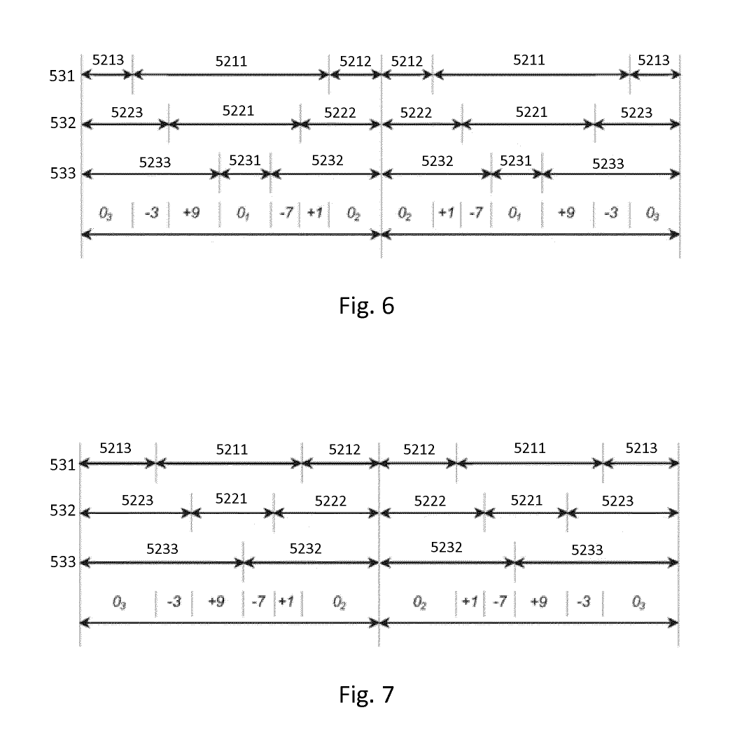

To modulate the supply of the voltage supply to the load, a modulation technique may be used to determine the timing for the switching of the bidirectional switches. One known method of controlling the switching of the bidirectional switches is a Space Vector Modulation (SVM) technique. Two typical SVM techniques or schemes, are exhibited in FIG. 6 and FIG. 7. In both these figures, the horizontal axis (x-axis) is considered to be time, and the references on the vertical axis (y-axis) considered to be the output node to which different bidirectional switches are associated.

The SVM techniques illustrated by FIGS. 6 and 7 apply a repeated sequence (i.e. that sequence shown in the respective FIGS.), or modulation period, of vectors to the array of bidirectional switches to regulate the modulation of the matrix converter. A vector may be understood to comprise the information as to which bidirectional switches are active or turned on at a given moment. For example, in FIG. 6 a vector ‘0₃’ is initially active. This corresponds (as indicated in FIG. 6) to the third 5213, sixth 5223 and ninth 5233 bidirectional switches being in the on-state.

An ‘active vector’ is defined to be a vector in which an output voltage is provided (i.e. there is voltage between at least one pair of the output nodes). For example, the vector ‘−3’ corresponds to the first 5211 sixth 5223 and ninth 5233 bidirectional switch being in the on-state. As such, the first output node is connected to the first input node; whilst the second and third output nodes are both connected to the third input node. There may therefore be a voltage difference between both the first and second output node and the first and third output node (each corresponding to the voltage difference between the first and third input node).

A ‘zero vector’ is defined to be a vector in which no output voltage is created (i.e. the voltage at each output node relative to a reference voltage is the same). An exemplary zero vector is the abovementioned vector ‘0₃’ in which all three output nodes are connected to the third input node. As such, there is no or negligible voltage difference between the first, second and third output nodes (as each output node is at the same voltage).

The length of time each active vector is applied to the array of bidirectional switches (pulse width) will determine: the average output voltage angle and magnitude; and the input current angle. In this way, if the input phase voltages are tracked, the SVM input current angle can be synchronised to the supply and unity displacement factor can be achieved at the input. Similarly, if the output voltage and angle are continuously changed, a desired sinusoidal output may be achieved.

Remaining time within the modulation period, i.e. the repeated sequence of vectors, is filled with zero vectors. Each zero vector also has an associated pulse width corresponding to the length of time each said zero vector is applied to the array of bidirectional switches. There may therefore be considered to be a minimum pulse width, that being the shortest single pulse width of any active or zero vectors applied in the modulation period.

The modulation index corresponds to the proportion or fraction of the modulation period that is filled with active vectors. Typically, a modulation index above 0.86 is considered over-modulation in the matrix converter. This is generally considered to be the theoretical maximum modulation index used in SVM without causing distortion of waveforms at the input or output.

FIG. 6 shows a SVM technique employing three zero vectors (3-zero method) to carry out the full modulation. In other words, within the modulation period three different zero vectors (‘0₁’, ‘0₂’ and ‘0₃’) are engaged. ‘0₁’ corresponds to the first 5211, fourth 5221 and seventh 5231 bidirectional switches being active. ‘0₂’ corresponds to the second 5212, fifth 5222 and eighth 5232 bidirectional switches being active.

FIG. 7 shows a SVM technique employing two zero vectors (2-zero method) to carry out the full modulation. In other words, within the modulation period two different zero vectors (‘0₃’ are ‘0₂’) are engaged.

Four active vectors are employed in both presented SVM schemes. ‘−3’ corresponds to the first 5211, sixth 5221 and ninth 5233 bidirectional switch being active. ‘+9’ corresponds to the first 5211, fourth 5221 and ninth 5233 bidirectional switch being active. ‘−7’ corresponds to the first 5211, fourth 5221 and eighth 5232 bidirectional switch being active. ‘+1’ corresponds to the first 5211, fifth 5222 and eighth 5232 bidirectional switches being active. It will be understood to the skilled person that other possible active vectors are available without expanding outside the scope of the present invention.

With reference to FIG. 6, as the modulation index is increased, the minimum pulse width occurs when the zero vector ‘0₁’ is made small. This may cause a small off-on-off time to be demanded from a transistor in one of the bidirectional switches by the modulation scheme, potentially causing undue thermal stress within the transistor.

Similarly, with reference to FIG. 7, a small off-on-off time may be demanded as the active vectors become small (between ‘+9’ and ‘−7’ for example).

However, if the switching between different bidirectional switches, i.e. changing the applied vector, is made according to the commutation sequence described with reference to FIG. 4, the small off-on-off time may be avoided. As such, each vector has an absolute minimum pulse width, equivalent to the length of time th. Preferably, this length of time is no less than 2.5 μs, optionally no less than 3.5 μs.

The length of the absolute minimum pulse width may depend, for example, on the thermal characteristics of the bidirectional switch. For example, if the bidirectional switches comprise insulated gate bipolar transistors, this length of time may be 2.5 μs. Higher power devices may require a larger minimum pulse width. Similarly, lower power devices may only require a smaller (than 2.5 μs) minimum pulse width.

In one example, limiting the minimum pulse width to be no less than 2.5 μs corresponds to limiting the modulation index of the matrix converter to 0.75 when using 3 zero SVM (FIG. 6) with a transistor switching frequency of 12.5 kHz. Limiting the modulation depth in a 3 zero SVM forces the vector 0₁, which separates ‘+9’ and ‘−7’, to be a minimum value (i.e. held for a minimum length of time) and prevents small pulses.

It may therefore be seen that one method of limiting the minimum pulse width (and hence the commutation sequence) may be to limit the modulation index of the matrix converter to be no more than a predetermined maximum modulation index, for example, 0.75. Optionally, the modulation index may be limited to being no less than a predetermined minimum modulation index. In some embodiments, there may be a predetermined maximum modulation index and a predetermined minimum modulation index.

When using a 2-zero SVM (FIG. 7), during a typical operation, active vectors ‘+9’ and ‘−7’ may become too small, and the switch 5221 may be switched off-on-off too rapidly. This may, for example, occur during every change of input or output sector as the input or output angle approaches the next sector boundary (e.g. every 60° of phase, for example, when there is a crossing between a pair of phases of the three-phase input). Limiting the length of time any given transistor may switch, that is limiting the minimum pulse width of a bidirectional switch, mitigates this effect.

However, one effect of limiting the modulation index or minimum pulse width may be that the maximum output voltage of the converter may be limited. Distortion may be introduced into the modulated signal, as the real output may no longer be the same as the desired output in the event that small vectors are lengthened, as any changes occurring in the demanded output during a minimum pulse width time will be lost.

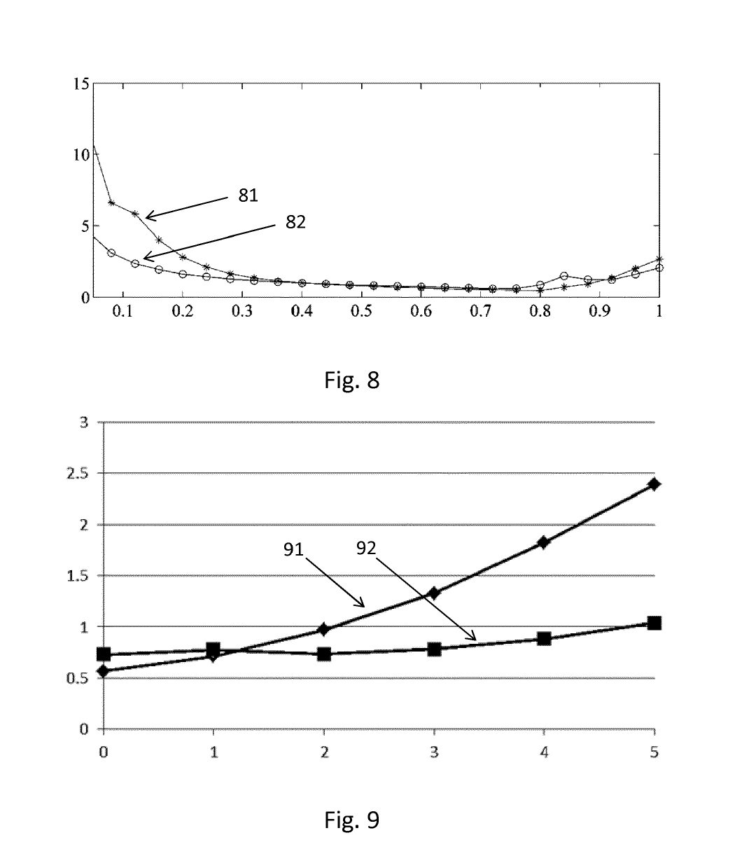

FIG. 8 depicts the simulated total harmonic distortion (THD) of the output current waveform (y-axis) over an increasing modulation index (x-axis, up to a maximum of one), for both a 3-zero SVM method 81 and a 2-zero SVM method 82.

The minimum time period between any transistor switch is set to an exemplary 1 μs. It can be seen that the THD generally decreases as the modulation index increases. However, as the modulation index reaches around 0.8, the limited pulse width (i.e. 1 μs) is imposed, and as such the modulated output is distorted. Accordingly, the THD increases.

FIG. 9 depicts the simulated total harmonic distortion (THD) of the output current waveform (y-axis) over an increasing commutation hold time (x-axis, up to a maximum of 5 μs). For the simulation, the maximum modulation index was set to 0.77. Both a 3-zero SVM method 91 and a 2-zero SVM method 92 have been simulated. For the 3-zero SWM method 91, there is a general upwards trend for the THD as commutation hold time increases. However, the 2-zero SVM method 92 remains substantially level. In some applications, therefore, the 2-zero method with a commutation hold time (e.g. >2.5 μs) may prove a more effective modulation method.

A 5 μs time period may be the maximum value to which the minimum hold time is set.

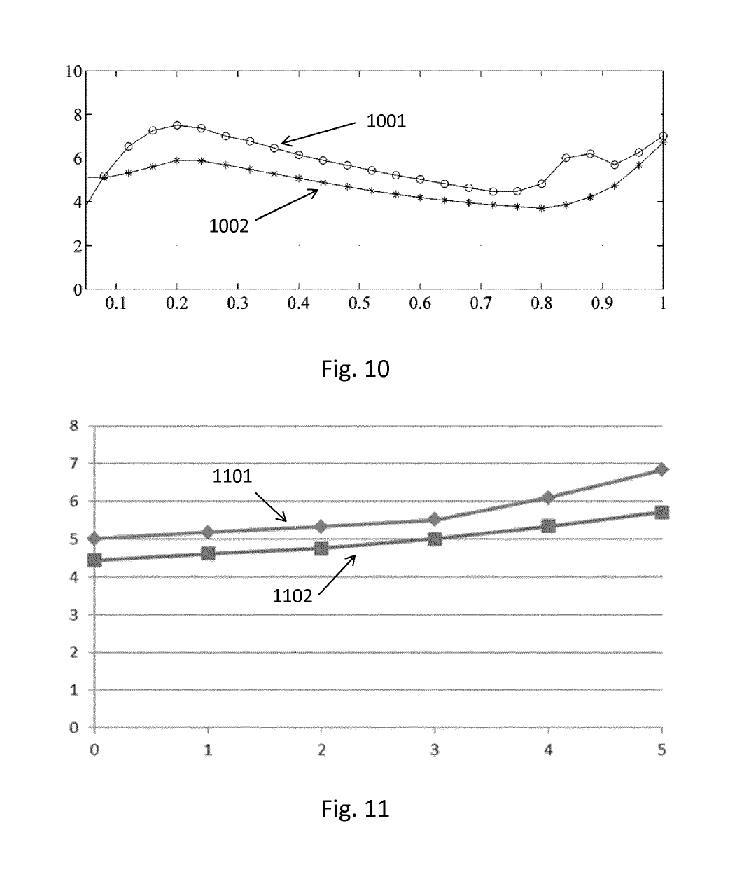

FIG. 10 depicts the simulated total harmonic distortion (THD) of the input current waveform (y-axis) over an increasing modulation index (x-axis, up to a maximum of one), for both a 3-zero SVM method 1001 and a 2-zero SVM method 1002. Again, the minimum time period between any transistor switch is set to an exemplary 1 μs. It can be seen that the spectral performance of the 2-zero method is significantly better than the 3-zero method at almost all operating points. Furthermore, the total harmonic distortion of the 3-zero method deteriorates as the limited pulse width (i.e. 1 μs) is imposed (when the modulation index is greater than 0.8). The THD of both techniques deteriorates significantly when entering the over modulation region (>0.86).

FIG. 11 depicts the simulated total harmonic distortion (THD) of the input current waveform (y-axis) over an increasing commutation hold time (x-axis, up to a maximum of 5 μs). For the simulation, the modulation index was set to 0.77, and both a 3-zero SVM method 1101 and a 2-zero SVM method 1102 have been simulated. It can again be seen that the results from the 2-zero method offer improved THD, and therefore performance, over the 3-zero method.

The performance of a 2-zero space vector modulation technique is demonstrated above to provide significant improvements in the quality of the modulated signal. It may therefore be preferable to provide a matrix converter that operates on a 2-zero space vector modulation technique having a commutation sequence with a commutation hold time.

Although not herein discussed, other methods of space vector modulation, such as the 1-zero SVM technique, may be used without departing from the scope of this invention.

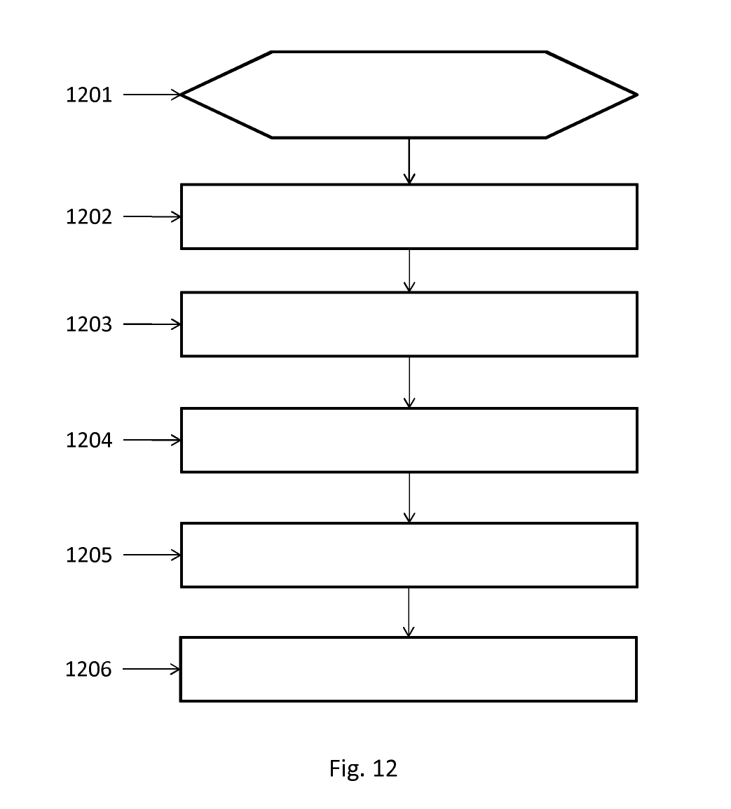

FIG. 12 illustrates a flowchart for a commutation sequence between a first and second bidirectional switch provided by the invention. The commutation sequence switches a bidirectional connection to an output node from a first input node to a second input node, wherein the first input node is connectable to the output node by a first bidirectional switch comprising a first transistor and a first diode arranged in series; and a second transistor and a second diode arranged in series, wherein the first and second transistor are arranged back-to-back; and the second input node is connectable to the output node by a second bidirectional switch comprising: a third transistor and a third diode arranged in series; and a fourth transistor and a fourth diode arranged in series, wherein the third and fourth transistor are arranged back-to-back, wherein the conductivity of each transistor is controllable by a controller to switch between a higher, on, conductivity and a lower, off, conductivity.

Initially 1201 both the first and second transistors are on and thereby the first bidirectional switch is on. Furthermore, at the same initial point, both the third and fourth transistors are off, and thereby the second bidirectional switch is off.

At a first point in time 1202, the first transistor is switched off.

At a second point in time 1203, the third transistor is switched on;

At a third point in time 1204, the second transistor is switched off;

At a fourth point in time 1205, the fourth transistor is switched on, and is latched to remain on and may not switch off;

At a fifth point in time 1206, no less than a predetermined time period after the fourth point in time, the fourth transistor is unlatched and may switch off

This predetermined time period may, for example, be no less than 2.5 μs, for example no less than 3.5 μs.

As explained above, a FPGA may be used to define a state machine which controls the switch state sequence. The actual time periods between switching states values may for example be controllable by a microcontroller, or they may be fixed.

Other variations to the disclosed embodiments can be understood and effected by those skilled in the art in practicing the claimed invention, from a study of the drawings, the disclosure, and the appended claims. Other bidirectional switches than explicitly herein disclosed will be known to the person skilled in the art, for example, a diode bridge bi-directional switch cell. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A matrix converter (1) comprising:
m input nodes (111, 112) for connection to an m-phase voltage source (100), where m is at least one:
n output nodes (130) for connection to an n-phase load (140), where n is at least one and at least one of m or n is two or more;
m×n bidirectional switches (121, 122), wherein each bidirectional switch is connected between a single input node and a single output node, such that each output node is selectively connectable to each input node by a bidirectional switch; and
a controller connected to control the conductivity of the said bidirectional switches, such that the bidirectional connect-on between each input node to each output node is selectively controllable,
wherein the controller is adapted such that the minimum time period between chancing the conductivity of any single bidirectional switch is no less than a predetermined time period.

2. The matrix converter of claim 1 wherein:
each bidirectional switch comprises at least one transistor;
the controller is connected to control the conductivity of each transistor;
and the controller is adapted such that the minimum time period between changing the conductivity of any single transistor is no less than the predetermined time period.

3. A matrix converter of claim 1, wherein the controller comprises a field-programmable gate array, FPGA.

4. The matrix converter of claim 1, wherein the predetermined time period is dependent upon the n-phase load driven by the output nodes.

5. The matrix converter of claim 1, wherein at least one capacitor (103) is connected between each of the input nodes.

6. The matrix converter of claim 1, wherein each output node is bidirectionally connected to only one input node at a time.

7. The matrix converter of claim 1, wherein each bidirectional switch (121) comprises: j
a first transistor (211) and a first diode (212) arranged in series; and
a second transfer (221) end a second diode (222) arranged in series,
wherein the first and second transistor are arranged back-to-back, such that the bidirectional switch is configurable to provide a first unidirectional connection from the associated input node to the associated output node, or a second unidirectional connection from the said output node to the associated input node.

8. The matrix converter of claim 7 where each output node is unidirectionally connected to no more then two input nodes at a time.

9. The matrix converter of claim 1, wherein the controller is further adapted such that the predetermined time period is no less then 2.5 μs.

10. The matrix converter of claim 1, wherein the controller is further adapted soon that the predetermined time period is no less than 3.5 μs.

11. The matrix converter of claim 1, further comprising a microcontroller connected to the FPGA, the microcontroller being adapted to select to which input node an output node is bidirectionally connected.

12. A method of switching a bidirectional connection to an output node from a first input, node to a second input node, wherein the first input node is connectable to the output node by a first bidirectional switch comprising a first transistor and a first clods arranged in series: and a second transistor and a second diode arranged in series, wherein the first and second transistor are a ranged back to back: and the second input node is connectable to the output node by a second bidirectional switch comprising: a third translator and a third diode arranged in series, and a fourth transistor and a fourth diode arranged in series, wherein the third and fourth translator are arranged back-to-back, wherein the conductivity of each transistor is controllable by a controller to switch between a higher, on, conductivity and a lower, off, conductivity, at an initial state (1201) the first and second transistor are both on, and the third and fourth transistor are both off,
the method comprising:
at a first point in lime (1202), switching the first transistor off;
at a second point In time (1203), switching the third transistor on;
at a third point In time (1204), switching the second transistor of;
at a fourth point in time (1205), switching the fourth transistor on; characterized in that the method further comprises:
at the fourth point in time, latching the fourth translator to remain on;
at a fifth point in time (1206), unlatching the fourth transistor, wherein the fifth point in time is no less than a predetermined time period after the fourth point in time.

13. The method of claim 12 adapted wherein there is a predetermined maximum time period between at least one of the following: the first and second point in time; the second and third point in time; and the third and fourth point in time.

14. The method of claim 12, wherein the controller is a field-programmable gate array.

15. A Method of operating a matrix converter having at least one output node and at least two input nodes wherein each output node is bidirectionally connected to each input node by a bidirectional switch, the method comprising:
using a space vector modulation technique to control the order of switching of the bidirectional connections between the at least one output node and the at least two input nodes,
wherein the step of switching of the bidirectional connection is performed as claimed in claim 12.

16. A matrix converter of claim 2, wherein the controller comprises a field-programmable gate array, FPGA.

17. The matrix converter of claim 2, wherein the predetermined time period is dependent upon the n-phase load driven by the output nodes.

18. The matrix converter of claim 2, wherein at least one capacitor (103) is connected between each of the input nodes.

19. The matrix converter of claim 2, wherein each output node is bidirectionally connected to only one input node at a time.

20. The matrix converter of claim 2, wherein each bidirectional switch (121) comprises:
a first transistor (211) and a first diode (212) arranged in series: and
a second transistor (221) and a second diode (222) arranged in series,
wherein the first and second transistor are arranged back-to-back. such that the bidirectional switch is configurable to provide a first unidirectional connection from the associated input node to the associated output node or a second unidirectional connection from the said output node to the associated input node.
